(19) United States
(12) Patent Application Publication
(10) Pub. No.: US 2012/0166541 A1
(43) Pub. Date: Jun. 28, 2012

(54) SYSTEMS AND METHODS FOR COLLECTING INFORMATION OVER A PEER TO PEER NETWORK

(75) Inventors: Soufiane Rouibia, Nantes (FR); Bastien Casalta, Nantes (FR)

(73) Assignee: TRIDENT MEDIA GUARD TMG, St. Sebastien Sur Loire (FR)

(21) Appl. No.: 13/389,443

(22) PCT Filed: May 26, 2011
(86) PCT No.: PCT/IB11/52298

§ 371 Date: Mar. 9, 2012

(30) Foreign Application Priority Data
Jun. 8, 2010 (FR) 10 54510

(51) Int. Cl. G06F 15/16

(52) U.S. Cl. 709/204

(57) ABSTRACT

A method of collecting information concerning peers of a peer-to-peer network is disclosed. The network includes at least one peer running exchange software configured to broadcast data to at least one client according to a selective exchange protocol enabling the peer to apply a selection of the clients to which data are transferred, this selection being made on the basis of one or more characteristics of the clients.

### FIELD OF THE DISCLOSURE

The present disclosure relates to a method and a device for collecting information relating to peers of a peer-to-peer network exchanging a content in said network.

Such a peer-to-peer network may be, for example, BitTorrent, e-Donkey, Ares, Gnutella1, Gnutella2, and other such networks.

### BACKGROUND OF THE DISCLOSURE

The new generations of peer-to-peer networks involve distributed systems enabling information in the peer-to-peer network to be identified and obtained. These distributed systems rely on the creation of an overlay network overlaying the peer-to-peer network. In this overlay network, each node is identified and can communicate with the other nodes. The overlay network for example implements a distributed hash table, hereinafter designated by its acronym “DHT”, and which is described for example in the publication by RIPEANU, FOSTER entitled “Mapping the Gnutella Network: Macroscopic Properties of Large-Scale Peer-to-Peer Systems”.

By virtue of the use of DHT, each peer of the peer-to-peer network becomes a mini-directory.

The peer-to-peer networks also implement the peer exchange technique, by which each peer exchanges with the peers to which it is connected the coordinates in the network of the peers that it knows and which distribute the same content. This exchange is made just after the first connection message.

The peers of the peer-to-peer network seeking to download a content in the peer-to-peer network generally recover a list of peers interested in the same content from a central directory of the network. To be served as rapidly as possible, each peer seeks to increase this list of peers.

The peer exchange technique or the interrogation of a DHT is a way of achieving this objective. Like other advantages, the use of a DHT or the peer exchange technique makes it possible to use the bandwidth of the peers of the network which download to search for peers and information concerning the content present in the network, instead of using the bandwidth of the server.

However, the information recovered in this way is not always reliable. In practice, certain peers may broadcast, via the DHT or by sending addresses according to the peer exchange technique, incorrect addresses, whether intentionally or not, these addresses not corresponding to peers of the network because they do not exist, because they are printer addresses or even because they are addresses of servers that have nothing to do with the peer-to-peer network.

It may prove difficult to check the accuracy of these addresses for a number of reasons: the connection to each of these addresses to check its existence is costly in time and in resources. Furthermore, certain addresses, although they exist, may not respond to a connection attempt for reasons such as the fact that the corresponding information technology terminals have already undertaken the maximum number of connections that they can support. Furthermore, certain addresses correspond to filtered peers, for example peers protected by a firewall, which cannot be reached if the connection is not initiated by the latter.

It is consequently difficult to collect information concerning the peers of a peer-to-peer network, the aim of such information being, for example, to carry out statistical studies on the download volumes and the number of copies of certain contents present on the peer-to-peer networks, or being to prevent the illicit downloading by peers of a peer-to-peer network of works protected by intellectual property rights.

There is consequently a need to collect information relating to peers of a peer-to-peer network in a manner that is reliable and relatively simple to implement.

### SUMMARY OF THE DISCLOSURE

The aim of embodiments of the disclosure is to satisfy this need and achieves it, according to one of its aspects, by virtue of a method of collecting information concerning peers for a peer-to-peer network, the network comprising at least one peer running exchange software configured to broadcast data to at least one client according to a selective exchange protocol enabling the peer to apply a selection of the clients to which data are transferred, this selection being made on the basis of one or more characteristics of the clients,

a method in which:

a search is conducted to find:
at least one directory node of an overlay network overlaying said peer-to-peer network, said directory node being associated with at least one predefined information item,
and/or
at least one directory node of the peer-to-peer network, said directory node being associated with said predefined information item and listing peers of the peer-to-peer network,

the address in the peer-to-peer network of at least one controlled client is sent to said directory node of the overlay network and/or to said peers of the network listed by the directory node of the peer-to-peer network, so as to enable at least one peer of the peer-to-peer network to connect to said controlled client, and,

information relating to said connected peer is received via the controlled client to which at least one peer of the network is connected.

The sending of the address in the peer-to-peer network of at least one controlled client to one or more directory nodes of the overlay network and/or to the peers of the network listed by the directory node of the peer-to-peer network enables the address of the controlled client to be broadcast rapidly in the peer-to-peer network.

By virtue of embodiments of the disclosure, peers of the network that have recovered the address of the controlled client connect to the latter. There is thus an assurance that the addresses recovered by the controlled client by virtue of these connections correspond to genuine peers of the network.

Because it is the peers of the peer-to-peer network that connect to the controlled client, when these peers are filtered by the firewall, a communication can take place with these peers and these communications can be exploited to check the addresses of these peers, which further reinforces the reliability of the information collected.

The information can be implemented for informative purposes, that is to say to know which contents are the most downloaded and the most reproduced in the peer-to-peer network.

Embodiments of the disclosure may also be implemented for a repressive purpose, in order to determine which of the peers of the peer-to-peer network illegally download content protected by intellectual property rights.

The peer-to-peer network may be decentralized and a search may be conducted to find at least one directory node of the overlay network overlaying the peer-to-peer network associated with at least one predefined information item, then the address in the peer-to-peer network of at least one controlled client may be sent to said directory node. This address of the controlled client may be sent to said directory node and be presented as associated with said predefined information item.

It is thus possible to check the publication of the address of the controlled client in the overlay network, so that the address of the controlled client is communicated to the peers contacting the directory node of the overlay network and interested in said predefined information item.

A search can be conducted to find at least one directory node of the peer-to-peer network associated with said predefined information item and listing peers of the peer-to-peer network and the address in the peer-to-peer network of at least one controlled client may be sent to the peers listed by this directory node. This address of the controlled client may be sent to said directory node and be presented as associated with said predefined information item.

By virtue of the method according to the disclosure, the address of the controlled client is sent to peers interested in said information item.

The predefined information item comprises, for example, at least one out of an identifier of a content that has been or is to be broadcast in the peer-to-peer network, such as, for example, a hash of a file, an album or film title, or an address, in particular an IP address of a peer in the peer-to-peer network.

The information received by the controlled client when a peer connects to the latter may comprise, in addition to its address, an identifier of the content and/or the percentage of the content already downloaded by this peer.

The information received by the controlled client when a peer connects to the latter may also comprise the version of the exchange software of said peer, the options that it supports and/or a hash of said peer.

The exchange software run by the peer may be of BitTorrent, eDonkey, Ares, Gnutella1 or Gnutella2 type.

The overlay network may implement a distributed hash table and the directory node of the overlay network associated with the predefined information item may be an internal tracker associated with said information item.

In this example, the address in the peer-to-peer network of a controlled client may be communicated to the internal tracker, so that peers of the peer-to-peer network can recover this address from the internal tracker to connect to the controlled client.

The directory of the peer-to-peer network may be a tracker associated with the predefined information item, and the list of peers listed by the latter as associated with the predefined information item may be recovered from the latter.

A connection can be made with all or some of the peers in the list recovered from the tracker and the address in the peer-to-peer network of at least one controlled client, notably according to the peer exchange technique, can be sent to said peer(s).

After the list of peers has been received and the address of the controlled client has been sent to said peers of the list, the connections with said peers can be interrupted.

The address in the network of the controlled client may comprise the IP address and/or the port of the controlled client.

Also the subject of the disclosure, according to another of its aspects, is a method for slowing down, even eliminating, the illegal propagation of protected data in a peer-to-peer network, the network comprising at least one peer running exchange software configured to broadcast data to at least one client according to a selective exchange protocol enabling the peer to apply a selection of the clients to which data are transferred, this selection being made on the basis of one or more characteristics of the clients, in which:
the method of collecting information as defined hereinabove is implemented, the predefined information being a digital audio, photo or video content, and,
according to the exchange software run by the peer, the controlled client sends to the peer or peers to which it is connected a message opposing said propagation. This message may be a false information item relating to said content sought, in particular a message indicating nonexistence of said content in the peer-to-peer network.

The method thus makes it possible to prevent the broadcasting of the content in the network by, for example, making the peer wanting to download it believe that the content does not exist.

Also the subject of the disclosure, according to another of its aspects, is an information technology system intended to collect information concerning peers for a peer-to-peer network, a peer-to-peer network in which at least one peer runs exchange software configured to broadcast data to at least one client according to a selective exchange protocol enabling the peer to apply a selection of the clients to which the data are transferred, this selection being made on the basis of data representative of one or more characteristics of the clients, the information technology system comprising at least one controlled client and being configured to:
search for at least one directory node of an overlay network overlaying said peer-to-peer network, said directory node being associated with at least one predefined information item and/or at least one directory node of the peer-to-peer network, said directory node being associated with said predefined information item and listing peers of the peer-to-peer network,
send to the directory node of the overlay network and/or to the peers of the peer-to-peer network listed by the directory node of the peer-to-peer network the address in the peer-to-peer network of at least one controlled client, so as to enable at least one peer of the peer-to-peer network to connect to said controlled client, and,
receive via the controlled client to which at least one peer of the network is connected information relating to said connected peer.

Also the subject of the disclosure, according to another of its aspects, is a computer program product comprising instructions that can be read by an information technology system comprising at least one microprocessor, these instructions controlling the operation of the information technology system so that, in a peer-to-peer network comprising at least one peer running exchange software configured to serve at least one client according to a selective exchange protocol enabling the peer to make a selection of the clients served on the basis of at least one characteristic of these clients:
at least one directory node of an overlay network overlaying said peer-to-peer network is sought, said directory node being associated with at least one predefined information item, and/or at least one directory node of the peer-to-peer network is sought, said directory node being associated with said predefined information item and listing peers of the peer-to-peer network,
the address in the peer-to-peer network of at least one controlled client is sent to the directory node of the overlay network and/or to the peers of the network listed by the directory node of the peer-to-peer network, so as to enable at least one peer of the peer-to-peer network to connect to said controlled client, and,
the controlled client to which at least one peer of the network is connected receives information relating to said connected peer.

### BRIEF DESCRIPTION OF THE DRAWINGS

The disclosure can be better understood from reading the following description of nonlimiting examples of implementation thereof, and on studying the appended drawing, in which:

FIG. 1 schematically represents an information technology architecture in which embodiments of the disclosure can be implemented,

FIG. 2 is a diagram of the tasks of a hacker for an overlay network overlaying a peer-to-peer network according to embodiments of the disclosure,

FIG. 3 is a diagram of the tasks of a hacker for a peer-to-peer network, and,

FIG. 4 is a diagram of the tasks of a controlled client according to embodiments of the disclosure.

### MORE DETAILED DESCRIPTION

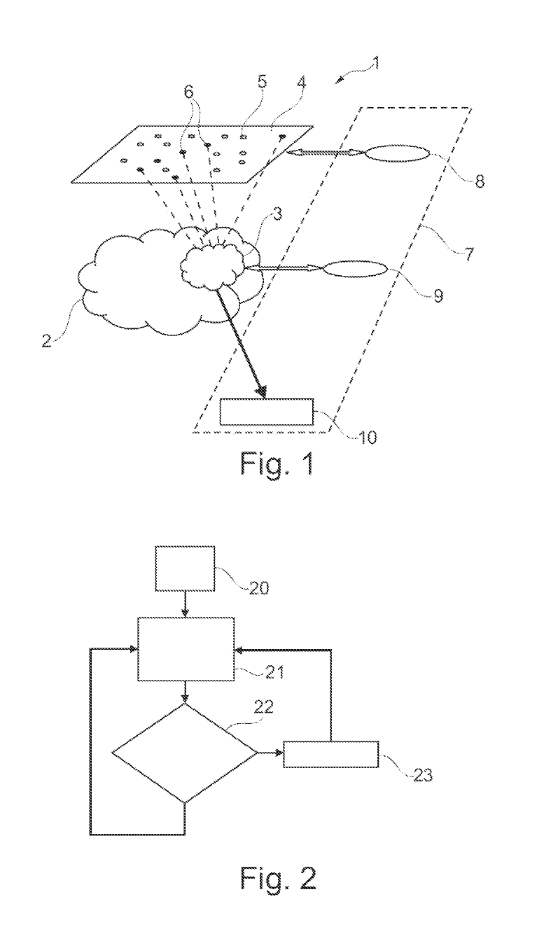

FIG. 1 schematically represents an information technology architecture 1 in which embodiments of the disclosure can be implemented.

The information technology architecture 1 comprises a peer-to-peer network 2 comprising at least one peer running exchange software configured to broadcast data to at least one client according to a selective exchange protocol enabling the peer to apply a selection of the clients to which data are transferred, this selection being made on the basis of one or more characteristics of the clients. In the example of FIGS. 1 to 4, the network 2 is a decentralized peer-to-peer network of BitTorrent type, but embodiments of the disclosure are not limited to this type of peer-to-peer network.

Contents can be exchanged in the peer-to-peer network 2.

These are, for example, audio files, for example of *.wav, *.aif, *.caf, *.cda, *.atrac, *.omg, *.at3, *.oga, *.fisc, *.mp3, *.ogg, *.vqf, *.vql, *.vqe, *.wma, *.au, *.aac, *.mp4 or *.m4a format.

There may be video files of *.arr, *.mpg, *.mov, *.esf, *.wmv, *.dvx, *.qt, *.avi and other such formats.

There may even be images in *.jpg, *.bmp, *.bng, *.tif or *.eps format.

There may also be archive contents in *.zip or *.rar format for electronic books in *.pdf format, or other such files.

The network 2 comprises a plurality of peers, some of which are target peers 3 which are interested in the same content present in the network 2 and associated with a predefined information item. The predefined information item is, for example, the content to be distributed or an identifier of said content, a file hash, an album or film title.

An overlay network 4 overlaying the peer-to-peer network 2 may be provided. This is, in the example considered, a distributed hash table (DHT).

This overlay network 4 comprises a plurality of nodes 5. Among these nodes 5, some nodes 6 are directory nodes for the predefined information item. The target peers 3 are likely to contact these directory nodes 6 when they want to download the content associated with the predefined information item.

As represented in FIG. 1, the architecture 1 comprises an information technology system 7 intended to collect information on the peers 3 of the peer-to-peer network 2.

This information technology system 7 comprises for example at least one hacker 8 configured to interact with the overlay network 4, at least one hacker 9 configured to interact with the peer-to-peer network 2, and at least one controlled client 10 to which target peers 3 can connect.

FIG. 2 is a diagram of the tasks executed by a hacker 8 according to an exemplary implementation of the disclosure.

This hacker 8 is configured to search in the overlay network 4 for the directory nodes 6 associated with the predefined information item, these directory nodes 6 being internal trackers in the example described. The predefined information item is, in the example considered, the hash of the content to be downloaded.

When the hacker 8 has been able to enter into contact with these internal trackers 6, it communicates the address to them, for example the IP address and the port of the controlled client 10.

The target peers 3 of the peer-to-peer network 2 searching for the predefined information item and seeking to know the most peers 3 interested in the same information item will contact one or more internal trackers 6 and will recover from the latter the address in the peer-to-peer network of the controlled client 10.

In a step 20, the hacker 8 searches for an access point to the overlay network 4.

It connects for this to any peer of the peer-to-peer network 2 connected to the overlay network 4.

In the example illustrated, a single hacker 8 is used, but, in order to spread the address of the controlled client 10 more rapidly, a number of hackers 8 may be used.

In the step 21, the hacker 8 which has joined the overlay network 4 searches for the nodes 5 of the overlay network 4 that are close to the predefined information item sought. In this step 21, which is conventional with a DHT, the hacker 8 recovers a list of nodes of the overlay network 4.

In step 22, the hacker 8 asks the node closest to the predefined information item if it is a directory for said information item, in other words whether it is an internal tracker 6 for said predefined information item. In the affirmative, the hacker 8, in a step 23, informs this internal tracker 6 of the IP address and the port of the controlled client 10, so that this address is published on the overlay network 4 and is thus communicated by the internal trackers 6 to the target peers 3 when the latter interrogate the internal trackers 6 to download the content associated with said predefined information item.

In the negative, or after having executed the step 23, the hacker 8 returns to the step 21.

Embodiments of the disclosure may also implement one or more hackers 9 configured to interact with the peer-to-peer network 2.

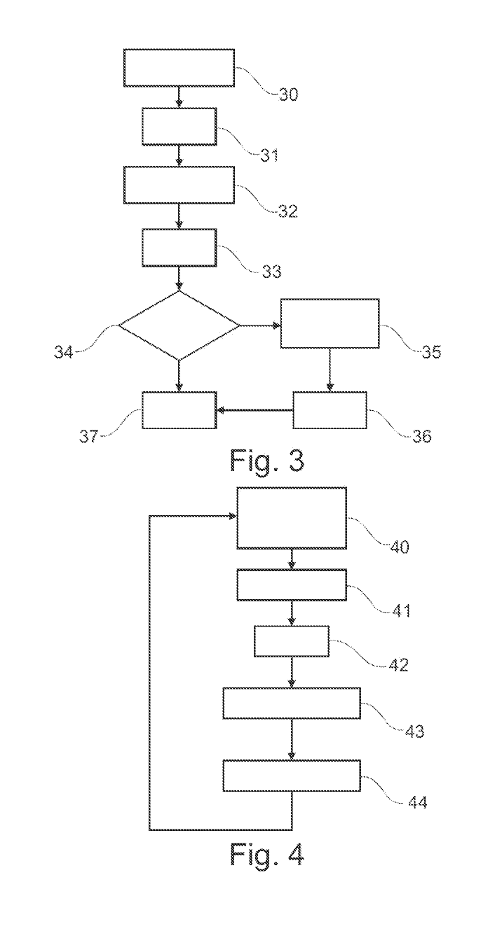

A hacker 9 may operate according to the diagram represented in FIG. 3.

In a first step 30, this hacker 9 recovers the torrent file of the content associated with the predefined information item, this file enabling it, in a step 31, to connect to the tracker of the peer-to-peer network 2.

In a step 22, the hacker 9 recovers from the tracker a first list of peers 3 associated with the predefined information item.

In a step 33, the hacker 9 connects to each of the peers 3 included in the list that it has just received and will analyze the options supported by each of said peers in a step 34.

If the peer implements the peer exchange technique, the hacker 9 and the peer, in a step 35, mutually send the IP addresses and the ports of the peers that they list around the same content to be downloaded. In this step 35, the hacker 9 may simply send to the peer 3 the IP address and the port of the controlled client.

In a step 36, the addresses returned by the peer 3 are stored by the hacker 9 and added to its list of contacts.

On completion of this step 36, or when the hacker 9 observes that the peer 2 does not implement the peer exchange technique, the connection with the peer 2 is interrupted in a step 37.

An example of operation of a controlled client 10 will now be described with reference to FIG. 4. The controlled client 10 may, for example, be a simple server likely to connect to the peer-to-peer network 2. This server is, for example, configured to listen on the IP address and the port published by the hackers 8 and 9 previously described.

All the target peers 3 of the peer-to-peer network 2 that have recovered the address and the port of the controlled client 10 via the internal trackers 6 of the overlay network or via the hackers 9 will be able to connect to the controlled client 10.

In a step 42, the information received by the controlled client by virtue of the connection of the target peers 3, such as, for example, the address of the peers, the exchange software of the peers, the options supported by the peers or even the hash of the peers, the hash of the content or the percentage of the content already downloaded by the peers 3, can be analyzed by the controlled client 10, which makes it possible to check that the address received at the time of the connection truly corresponds to a peer running the exchange software, of BitTorrent type in the example considered.

In the step 43, this information is stored in a database.

When embodiments of the disclosure are applied to fight against the illegal propagation of data protected by intellectual property rights, the controlled client can execute a step 44 according to which, according to the exchange software, for example BitTorrent, eDonkey, Ares, Gnutella1 or Gnutella2, it sends to the target peer 3 a message comprising a false information item relating to said content, in particular a message indicating that the content sought by the latter does not exist.

Embodiments of the disclosure are not limited to the examples which have just been described.

The expression “comprising one” should be understood to mean “comprising at least one”, unless otherwise specified.

1. A method of collecting information concerning peers for a peer-to-peer network, the network comprising at least one peer running exchange software configured to broadcast data to at least one client according to a selective exchange protocol enabling the peer to apply a selection of the clients to which the data are transferred, this selection being made on the basis of one or more characteristics of the clients,
a method in which:
a search is conducted to find:
at least one directory node of an overlay network overlaying said peer-to-peer network, said directory node being associated with at least one predefined information item,
and/or
at least one directory node of the peer-to-peer network, said directory node being associated with said predefined information item and listing peers of the peer-to-peer network,
the address in the peer-to-peer network of at least one controlled client is sent to the directory node of the overlay network and/or to the peers of the peer-to-peer network listed by the directory node of the peer-to-peer network, so as to enable at least one peer of the peer-to-peer network to connect to said controlled client, and,
information relating to said connected peer is received via the controlled client to which at least one peer of the network is connected.

2. The method as claimed in claim 1, in which the peer-to-peer network is decentralized and in which a search is conducted to find at least one directory node of the overlay network overlaying the peer-to-peer network associated with said predefined information item and in which the address in the peer-to-peer network of at least one controlled client is sent to said directory node.

3. The method as claimed in claim 1, in which a search is conducted to find at least one directory node of the peer-to-peer network associated with said predefined information item and listing peers of the peer-to-peer network, and in which the address in the peer-to-peer network of at least one controlled client is sent to the listed peers.

4. The method as claimed in claim 1, in which the predefined information item comprises at least one out of an identifier of a content that has been or is to be broadcast in the peer-to-peer network and an address of a peer in the peer-to-peer network.

5. The method as claimed in claim 4, in which the predefined information item comprises an identifier of a digital audio and/or video content.

6. The method as claimed in claim 5, in which the information received by the controlled client comprises an identifier of the digital content and/or the percentage of said content already downloaded by the peer to which the controlled client is connected.

7. The method as claimed in claim 1, in which the information received by the controlled client comprises an identifier of the peer to which it is connected and/or the version of the exchange software of said peer.

8. The method as claimed in claim 1, in which the exchange software run by the peer (3) is of BitTorrent type.

9. The method as claimed in claim 2, in which the overlay network implements a distributed hash table and in which the directory node associated with the predefined information item is an internal tracker associated with said information item.

10. The method as claimed in claim 9, in which the address in the peer-to-peer network of a controlled client is communicated to the internal tracker, so that peers of the peer-to-peer network can recover this address from the internal tracker to connect to the controlled client.

11. The method as claimed in claim 8, in which the directory node of the peer-to-peer network is a tracker associated with the predefined information item and in which the list of the peers of the network listed by the latter as associated with the predefined information item are recovered from this tracker, and in which a connection is made to at least one of said peers.

12. The method as claimed in claim 11, in which a list of peers of the peer-to-peer network is received from at least one peer of the list recovered from the tracker, and in which the address in the peer-to-peer network of at least one controlled client is sent to said peer according to the peer exchange technique.

13. The method as claimed in claim 12, in which, after reception of the list of peers and after sending the address of the controlled client to said peer, the connection to said peer is disconnected.

14. The method as claimed in claim 1, in which the address in the peer-to-peer network of the controlled client comprises the IP address and the port of the controlled client.

15. A method for slowing down and/or eliminating, the illegal propagation of protected data in a peer-to-peer network, the network comprising at least one peer running exchange software configured to broadcast data to at least one client according to a selective exchange protocol enabling the peer to apply a selection of the clients to which the data are transferred, this selection being made on the basis of one or more characteristics of the clients, in which:
the method of collecting information as claimed in claim 1 is implemented, the predefined information item being a digital audio and/or video content, and
according to the exchange software run by the peer, the controlled client sends to the peer or peers to which it is connected a message opposing said propagation, a false information item relating to said sought content.

16. An information technology system intended to collect information concerning peers for a peer-to-peer network, in which at least one peer runs exchange software configured to broadcast data to at least one client according to a selective exchange protocol enabling the peer to apply a selection of the clients to which the data are transferred, this selection being made on the basis of data representative of one or more characteristics of the clients,
the information technology system comprising at least one controlled client (10) and being configured to:
search for at least one directory node of an overlay network overlaying said peer-to-peer network, said directory node being associated with at least one predefined information item and/or at least one directory node of the peer-to-peer network, said directory node being associated with said predefined information item and listing peers of the peer-to-peer network,
send to the directory node of the overlay network and/or to the peers of the network listed by the directory node of the peer-to-peer network the address in the peer-to-peer network of at least one controlled client so as to enable at least one peer of the peer-to-peer network to connect to said controlled client, and
receive via the controlled client (10) to which at least one peer (3) of the network (2) is connected information relating to said connected peer.

17. A computer program product comprising instructions that can be read by an information technology system comprising at least one microprocessor, these instructions controlling the operation of the information technology system so that, in a peer-to-peer network comprising at least one peer running exchange software configured to serve at least one client according to a selective exchange protocol enabling the peer to make a selection of the clients served on the basis of at least one characteristic of these clients:
at least one directory node of an overlay network overlaying said peer-to-peer network is sought, said directory node being associated with at least one predefined information item, and/or at least one directory node of the peer-to-peer network is sought, said directory node being associated with said predefined information item and listing peers of the peer-to-peer network,
the address in the peer-to-peer network of at least one controlled client is sent to the directory node of the overlay network and/or to the peers of the network listed by the directory node of the peer-to-peer network, so as to enable at least one peer of the peer-to-peer network to connect to said controlled client, and,
the controlled client to which at least one peer of the network is connected receives information relating to said connected peer.

18. A method according to claim 15, wherein the message opposing propagation is a false information item relating to said sought content.
